(19) United States
(12) Patent Application Publication
(10) Pub. No.: US 2007/0030484 A1
(43) Pub. Date: Feb. 8, 2007

(54) Spectrograph with segmented dispersion device

(75) Inventor: Radoslaw Sobczynski, Orange, CT (US)

Correspondence Address: ST. ONGE STEWARD JOHNSTON & REENS, LLC, 986 BEDFORD STREET, STAMFORD, CT, 06905-5619, US

(73) Assignee: Acton Research Corporation, Acton, MA (US)

(21) Appl. No.: 11/500,825

(22) Filed: Aug. 8, 2006

Related U.S. Application Data
(60) Provisional application No. 60/706,354, filed on Aug. 8, 2005.

(51) Int. Cl. G01J 3/28

(52) U.S. Cl. 356/328

(57) ABSTRACT

A spectrograph is disclosed generally comprising a radiation source and a dispersion device that includes a plurality of segments arranged adjacently along a plane upon which the radiation is incident, where each of the segments disperses the radiation differently than adjacent segments. In certain embodiments, each segment can be rotated and titled separately from the other segments. In some embodiments, the dispersed radiation is received by a detector in a plurality of spectral channels corresponding to the segments and including radiation of different spectral orders.

### CROSS-REFERENCE TO RELATED APPLICATIONS

This patent application claims the benefit of, under Title 35, United States Code, Section 119(e), U.S. Provisional Patent Application No. 60/706,354, filed Aug. 8, 2005.

### FIELD OF THE INVENTION

The present invention relates to a system for forming and recording the spectrum of a light source. More specifically, the invention relates to a spectrograph with an improved ability to segment and independently disperse various sub-ranges within the spectrum.

### BACKGROUND OF THE INVENTION

Devices for performing spectral analyses, such as spectrographs, are generally well known in the art. Today, such devices employ image sensors, such as Charge Coupled Device (CCD) sensors, that are highly sensitive to wide spectrums. The use of these types of modern electronic detector arrays facilitates both rapid analog-to-digital data conversion and rapid processing of the large amounts of information that these image sensors will generate. In order to take full advantage of these techniques, however, the optical systems preceding the sensor must be optimized.

The use of diffraction gratings has long been a well-known and effective way of previously separating the radiation into its constituent wavelength components. However, the modern sensors described above are sensitive to radiation in wide wavelength ranges that can extend from ultraviolet to infrared. Accordingly, in order to maximize the use of the number of available pixels in electronic detector arrays such as CCDs, it is desirable to apply a multi-order spectrum. Traditional gratings, however, suffer from the fact that spectra from several spectral orders results in some ambiguities in the analysis of the spectrum.

For example, a spectrograph fitted with a 1 K (1024 pixel) long CCD array as the light detector, operating in the 200-1 100 nm range, will have a resolution close to 0.9 nm per pixel. The same spectrograph, if set for a 0.1 nm resolution per pixel, will only be able to cover a 90 nm spectral range. This severely limits the spectral range for analysis, which is not useful for various forms of spectral analysis, such as atomic emission spectroscopy or Raman spectroscopy, which both require high resolution and coverage of a large spectral range.

Accordingly, it has been proposed to use a special type of grating and a cross-dispersing element that will provide radiation in a number of spectral orders with high spectral resolution. A typical spectrograph of this kind is an echelle spectrograph, such as that described, for example, in U.S. Pat. No. 6,628,383 to Hilliard. These gratings have groove spacings that are significantly larger than the wavelength to be measured, and the blaze angle—which is the angle between the normal to the reflecting groove facet and the normal to the grating surface—is typically about sixty degrees. This design causes an angular dispersion many times that of a standard plane grating.

However, while the echelle spectrograph produces high resolution and a large range by utilizing the vertical cross dispersion of the multi-order spectrum, it results in a number of disadvantages. Specifically, these spectrographs suffer from nonlinearities and low light throughput, and they require complicated deconvolution algorithms. Accordingly, such spectrographs, while somewhat expensive, still result in some lack of clarity with respect to spectral calibration and interpretation.

In certain, limited applications, different gratings having different dispersion properties have been employed. For example, the Split Grating Spectrograph employed in the OES System manufactured by Chromex, Inc. utilized a pair of gratings to allow simultaneous processing of optical spectra from different sources. Another device, the Double Dispersion Monochromator/Spectrograph manufactured by Solar TII, Ltd., uses a pair of gratings that can be employed to serially disperse a radiation beam. However, none of these devices has attempted to incorporate the use of a number of different gratings into a single source spectrograph in order to simultaneously disperse various portions of the single beam of radiation in order to overcome the disadvantages related to wide spectrum analyses described above.

A few grating designs have been suggested that employ multiple portions that each has different dispersion properties for diffracting radiation supplied by a single source. For example, it has been proposed to horizontally stack, or “laminate,” at least three layers of diffraction gratings, such as in the designs disclosed, for example, in U.S. Pat. Nos. 6,122,104 and 6,930,833 to Nakai et al., as well as International Patent Application No. WO 99/56159 by Templex Technology Inc. However, these designs are all necessarily limited in their application, as the layers are all fixed, and there is no ability to adjust their angular position relative to one another. Another design that has been proposed is a single grating having different dispersion properties at different locations on its surface, described in U.S. Pat. No. 6,844,973. In this design, the grating has blaze angles in different portions of its surface, and the grating is rotated. Again, however, this type of design does not permit the different portions to be rotated or tilted relative to each other to allow simultaneous, robust diffraction of the beam.

What is desired, therefore, is spectrograph that is able to maximize the advantages of modern electronic detector arrays. What is further desired is a spectrograph that does not result is ambiguities in the spectral analysis. What is also desired is a spectrograph that has very versatile, simultaneous diffraction capabilities.

### SUMMARY OF THE INVENTION

Accordingly, it is an object of the present invention to provide a spectrograph capable of diffracting radiation that will include a number of spectral orders.

It is a further object of the present invention to provide a spectrograph that produces spectra with high resolution.

It is yet another object of the present invention to provide a spectrograph that does not result in nonlinearities or low light throughput.

It is still another object of the present invention to provide a spectrograph that does not require complicated deconvolution algorithms.

It is another object of the present invention to provide a spectrograph with a very robust system for simultaneously diffracting different portions of a single radiation beam.

It is still another object of the present invention to provide a spectrograph that is not difficult or expensive to manufacture.

In order to overcome the deficiencies of the prior art and to achieve at least some of the objects and advantages listed, the invention comprises a spectrograph, including a radiation source that supplies radiation, a collimator that receives the radiation supplied by the radiation source and substantially collimates the radiation, and a dispersion device that receives the collimated radiation, the dispersion device comprising a plurality of segments each having a dispersion surface, wherein the segments are arranged adjacently along a plane upon which the radiation is incident, and wherein each of the segments disperses the radiation differently than adjacent segments.

In another embodiment, the invention comprises a spectrograph, including a beam of radiation, and a dispersion device that receives the beam of radiation, the dispersion device comprising a plurality of segments each having a dispersion surface, wherein the segments are arranged adjacently along a plane upon which the beam of radiation is incident, and wherein each of the segments disperses the radiation differently than adjacent segments.

In yet another embodiment, the invention comprises a spectrograph, including a beam of radiation, and a dispersion device that receives the beam of radiation, the dispersion device comprising a plurality of diffraction gratings, wherein the gratings are arranged adjacently along a plane upon which the beam of radiation is incident, and wherein each of the gratings disperses the radiation differently than adjacent gratings.

In some embodiments, the dispersion device further comprises a pivot axis about which each of the grating pivots separately from adjacent gratings. In certain embodiments, at least one of the gratings further comprises a pivot axis about which the at least one grating pivots separately from at least one other grating.

In certain embodiments, the invention further includes further comprising a detector that receives the dispersed radiation, wherein the dispersed radiation is received by the detector in a plurality of adjacent spectral channels corresponding to the plurality of adjacent segments, and wherein a first one of the channels includes radiation of a first spectral order and a second one of the channels includes radiation of a second spectral order.

In some of these embodiments, the dispersion device includes at least three gratings, and in some cases, the gratings are concave. In some of these embodiments, each of the segments has at least one edge proximal to an adjacent segment, wherein the edges extend substantially horizontally.

In certain embodiments, at least one of the gratings has a different blaze angle than at least one other grating, while in some embodiments, at least one of the gratings has a different groove spacing than at least one other grating, while in some cases, at least one of the gratings has a different reflective coating than at least one other grating.

In some embodiments, the dispersion device is a segmented focusing mirror, while in other embodiments, the segments are photonic crystals.

### BRIEF DESCRIPTION OF THE DRAWINGS

FIG. 1 is a schematic view of spectrograph in accordance with the invention.

FIG. 2 is a perspective view of the dispersion device of the spectrograph of FIG. 1.

FIG. 3A is a perspective view of a portion of the dispersion device of FIG. 2 showing the independent rotation of the segments thereof.

FIG. 3B is a perspective view of a portion of the dispersion device of FIG. 2 showing the independent rotation of the segments thereof.

FIG. 4 is a perspective view of a mirror of the spectrograph of FIG. 1.

FIG. 5 is an isometric view of the focal plane and incident radiation of the spectrograph of FIG. 1.

### DETAILED DESCRIPTION OF THE INVENTION

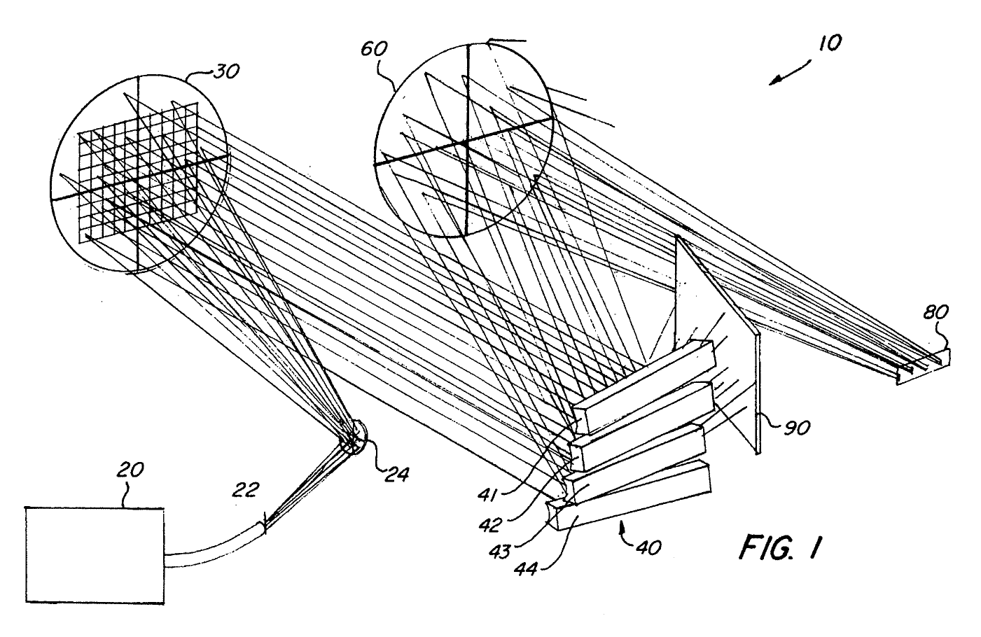

The basic components of one embodiment of a spectrograph with a segmented dispersion device in accordance with the invention are illustrated in FIG. 1. As used in the description, the terms “top,” “bottom,” “above,” “below,” “over,” “under,” “above,” “beneath,” “on top,” “underneath,” “up,” “down,” “upper,” “lower,” “front,” “rear,” “back,” “forward” and “backward” refer to the objects referenced when in the orientation illustrated in the drawings, which orientation is not necessary for achieving the objects of the invention.

The system 10 includes a light source 20, which may, for example, comprise a neon lamp, but which may be any source of radiation desired for a spectral analysis. The source 20 supplies the radiation via an entrance slit 22, which may, for example, be approximately 4 mm high. In some embodiments, this radiation exiting the entrance slit 22 is initially folded by a folding mirror 24.

The light is then directed to a collimator, such as a mirror 30, which collimates the radiation. The collimated radiation is reflected to a dispersion device 40, which separates the radiation into different wavelength components, as is further described below. This wavelength-dispersed radiation is then directed to a focusing mirror 60, which reflects the radiation to a focal plane 80. In some cases, a baffle plate 90 is provided to prevent interference by additional radiation reflected by the dispersion device 40.

In certain advantageous embodiments, the dispersion device is a diffraction grating 40. Generally, the grating 40 comprises a collection of reflecting or transmitting elements that are separated by a distance comparable to the wavelengths of the radiation being analyzed, such as, for example, a collection of reflecting grooves on a substrate.

In some embodiments, in order to prevent an ambiguous spectrum resulting from several spectral orders present in the radiation being dispersed, the dispersion device 40 is composed of a plurality of segments 41-44, each of which has the ability to disperse the incident radiation differently than adjacent segments. In certain embodiments, the dispersion device 40 includes at least three segments, thereby vertically dividing the radiation into at least three channels.

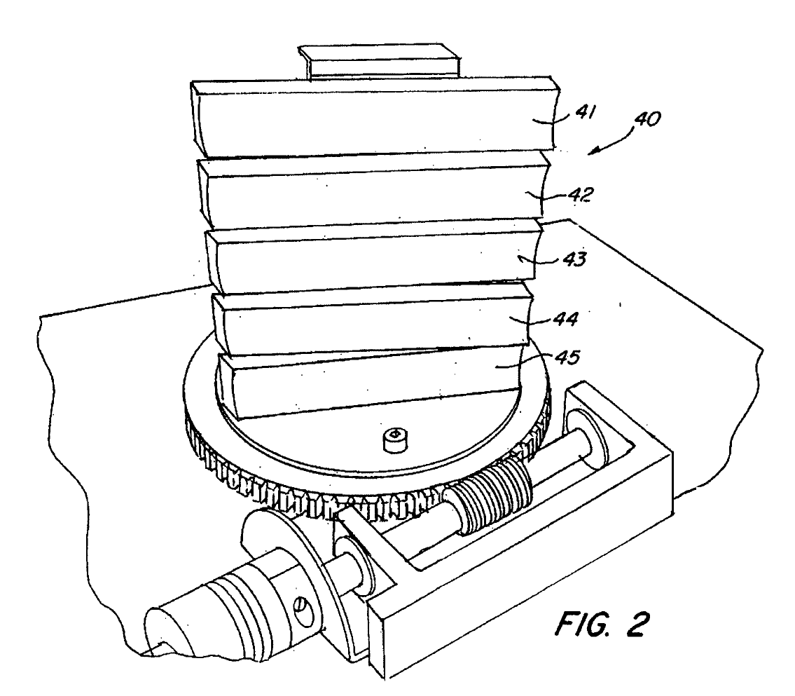

As noted above, in certain embodiments, it is advantageous to use a diffraction grating to effect the wavelength dispersion, an example of which is shown in detail in FIG. 2. In these cases, the dispersion device 40 comprises a plurality of gratings 41-45, which are positioned adjacent to one another along a plane upon which the collimated radiation from the collimator 30 is incident. As also noted above, in some cases, at least three gratings are employed, though the number of segments may vary depending on the width of the spectral range and the number of channels desired.

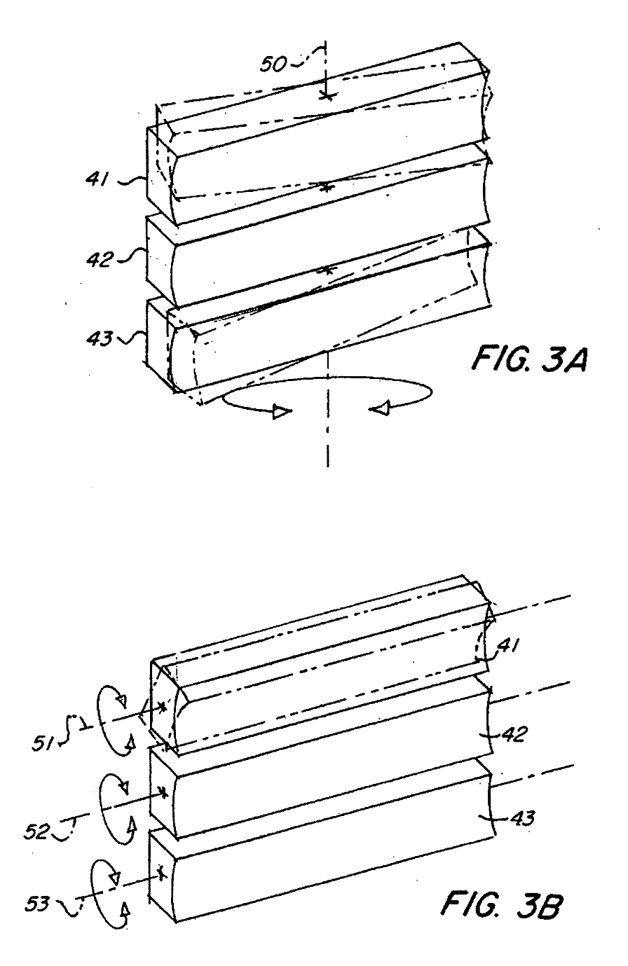

As shown in FIG. 3A, the gratings 41-43, which may be concave, are stacked along a common, vertical pivot axis 50. In this way, each of the individual gratings 41-43 can be pivoted relative to the adjacent gratings to change the angle of diffraction. As shown in FIG. 3B, each of the gratings 41, 42, 43 has a pivot axis 51, 52, 53, about which each individual segment is pivotable in order to individually tilt each of the individual gratings 41-43 relative to adjacent segments. In this way, each grating 41-43 can be adjusted about its vertical and horizontal axes by commands input manually or automatically from a computer in order to precisely orient each segment.

In addition to the ability to move the gratings 41-43 as described above, the individual segments may have inherent dispersion properties different from some or all of the other gratings. For example, each of the gratings may have a different blaze angle or a different groove spacing (or frequency), and each grating can thus be uniquely tailored to minimize light loss in a particular sub-range. Similarly, each grating may be coated with a different material, and thin filtering layers can be stacked thereon to suppress higher orders of diffraction. Further, the gratings may have different substrate materials or dimensions, and even the nominal surface figure may differ from segment to segment, and may be planar or, as noted above, be of concave shapes with varying radii.

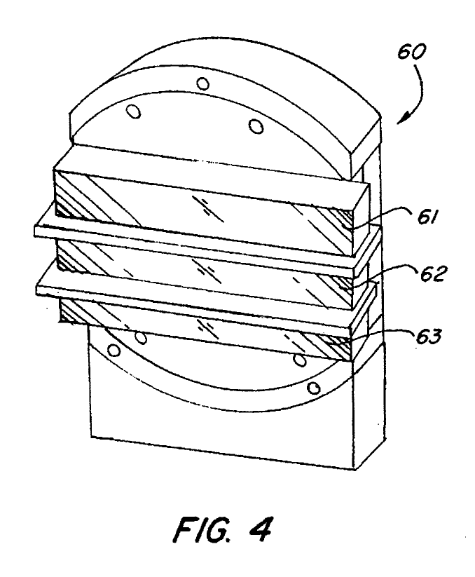

While the invention has been described in terms of segmenting the dispersion device 40, it should be understood that similar advantages may be achieved by segmenting the focusing mirror 60. Accordingly, as illustrated in FIG. 4, the mirror 60 may likewise be composed of a plurality of adjacent mirror segments 61-63. Like the separate segments of the dispersion element 40 described above, the mirror segments 61-63 can be independently pivoted in order to disperse the constituent wavelengths of the radiation.

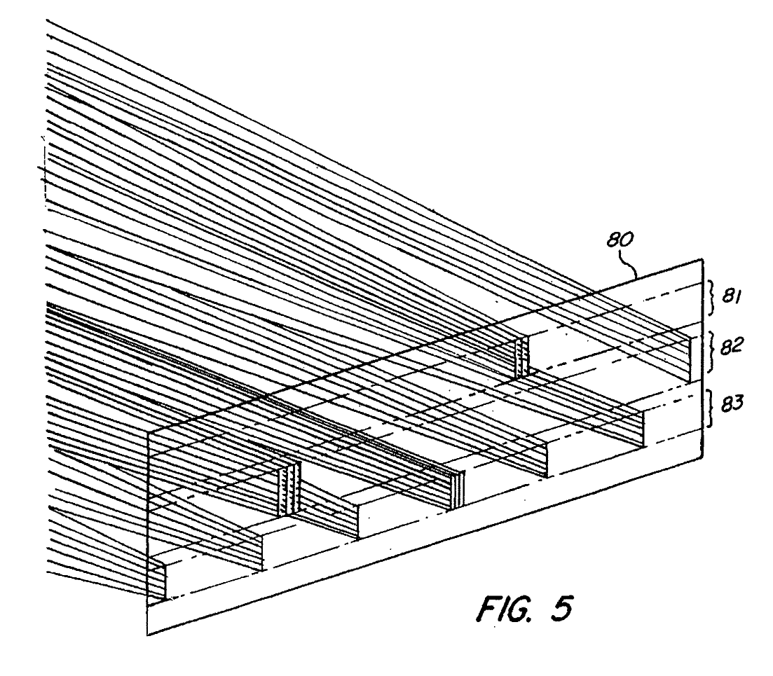

A detector, represented by the focal plane 80, such as, for example, a 1340×400 pixel array, receives the radiation incident thereon. As shown in FIG. 5, the radiation is received in a plurality of spectral channels 81, 82, 83, which correspond to the segments 41, 42, 43. In this way, spectral orders can be separated and channels with high resolution can be provided for various wavelength sub-ranges. For instance, in the example illustrated in FIG. 5, a high resolution channel 81 is produced for small wavelengths, another high resolution channel 82 is produced for medium wavelengths, and a third, low-resolution channel 83 is also provided for the longer wavelengths. By providing multiple strips of spectral bands in this way, the ambiguity discussed above can be avoided.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

What is claimed is:

1. A spectrograph, comprising:
a radiation source that supplies radiation;
a collimator that receives the radiation supplied by said radiation source and substantially collimates the radiation; and
a dispersion device that receives the collimated radiation, said dispersion device comprising a plurality of segments each having a dispersion surface;
wherein said segments are arranged adjacently along a plane upon which the radiation is incident; and
wherein each of said segments disperses the radiation differently than adjacent segments.

2. The spectrograph of claim 1, said dispersion device further comprising a pivot axis about which each of said segments pivots separately from adjacent segments.

3. The spectrograph of claim 1, wherein at least one of said segments further comprises a pivot axis about which said at least one segment pivots separately from at least one other segment.

4. The spectrograph of claim 1, further comprising a detector that receives the dispersed radiation, wherein the dispersed radiation is received by said detector in a plurality of adjacent spectral channels corresponding to said plurality of adjacent segments, and wherein a first one of said channels includes radiation of a first spectral order and a second one of said channels includes radiation of a second spectral order.

5. The spectrograph of claim 1, wherein said dispersion device comprises at least three segments.

6. The spectrograph of claim 5, wherein each of said segments has at least one edge proximal to an adjacent segment, wherein said edges extend substantially horizontally.

7. The spectrograph of claim 1, wherein said segments comprise diffraction gratings.

8. The spectrograph of claim 7, wherein said gratings are concave.

9. The spectrograph of claim 7, wherein at least one of said gratings has a different blaze angle than at least one other grating.

10. The spectrograph of claim 7, wherein at least one of said gratings has a different groove spacing than at least one other grating.

11. The spectrograph of claim 7, wherein at least one of said gratings has a different reflective coating than at least one other grating.

12. The spectrograph of claim 1, wherein said dispersion device comprises a segmented focusing mirror.

13. The spectrograph of claim 1, wherein said segments comprise photonic crystals.

14. A spectrograph, comprising:
a beam of radiation; and
a dispersion device that receives the beam of radiation, said dispersion device comprising a plurality of segments each having a dispersion surface;
wherein said segments are arranged adjacently along a plane upon which said beam of radiation is incident; and
wherein each of said segments disperses the radiation differently than adjacent segments.

15. The spectrograph of claim 14, said dispersion device further comprising a pivot axis about which each of said segments pivots separately from adjacent segments.

16. The spectrograph of claim 14, wherein at least one of said segments further comprises a pivot axis about which said at least one segment pivots separately from at least one other segment.

17. The spectrograph of claim 14, further comprising a detector that receives the dispersed radiation, wherein the dispersed radiation is received by said detector in a plurality of adjacent spectral channels corresponding to said plurality of adjacent segments, and wherein a first one of said channels includes radiation of a first spectral order and a second one of said channels includes radiation of a second spectral order.

18. The spectrograph of claim 14, wherein said dispersion device comprises a segmented focusing mirror.

19. The spectrograph of claim 14, wherein said segments comprise photonic crystals.

20. A spectrograph, comprising:
a beam of radiation; and
a dispersion device that receives the beam of radiation, said dispersion device comprising a plurality of diffraction gratings;
wherein said gratings are arranged adjacently along a plane upon which said beam of radiation is incident; and
wherein each of said gratings disperses the radiation differently than adjacent gratings.

21. The spectrograph of claim 20, said dispersion device further comprising a pivot axis about which each of said gratings pivots separately from adjacent gratings.

22. The spectrograph of claim 20, wherein at least one of said gratings further comprises a pivot axis about which said at least one grating pivots separately from at least one other grating.

23. The spectrograph of claim 20, further comprising a detector that receives the dispersed radiation, wherein the dispersed radiation is received by said detector in a plurality of adjacent spectral channels corresponding to said plurality of adjacent gratings, and wherein a first one of said channels includes radiation of a first spectral order and a second one of said channels includes radiation of a second spectral order.

24. The spectrograph of claim 20, wherein said dispersion device comprises at least three gratings.

25. The spectrograph of claim 20, wherein said gratings are concave.

26. The spectrograph of claim 20, wherein said dispersion device comprises at least three gratings.

27. The spectrograph of claim 20, wherein at least one of said gratings has a different blaze angle than at least one other grating.

28. The spectrograph of claim 20, wherein at least one of said gratings has a different groove spacing than at least one other grating.

29. The spectrograph of claim 20, wherein at least one of said gratings has a different reflective coating than at least one other grating.
